(19) United States
(12) Patent Application Publication
(10) Pub. No.: US 2019/0147435 A1
(43) Pub. Date: May 16, 2019

(54) SYSTEMS AND METHODS FOR PROCESSING ELECTRICAL ENERGY-BASED TRANSACTIONS

(71) Applicant: MASTERCARD INTERNATIONAL INCORPORATED, Purchase, NY (US)

(72) Inventors: Shawn Mehrhoff, Saint Ann, MO (US); Christopher T. Scholl, Saint Peters, MO (US)

(21) Appl. No.: 15/812,409

(22) Filed: Nov. 14, 2017

(51) Int. Cl. G06Q 20/34

(52) U.S. Cl. CPC G06Q 20/34

(57) ABSTRACT

An electronic payment card processing system and method includes at least one host computing device comprising at least one processor in communication with a memory device and a payment card issuer. The at least one host computing device is configured to: accept payment card transaction data; analyze the payment card transaction data to identify an electrical energy-based transaction, wherein the electrical energy-based transaction involves a purchase of a good or service by a cardholder in exchange for an amount of electrical energy payable to a merchant via the payment card; and submit the payment card transaction data for the identified electrical energy-based transaction to the payment card issuer for approval. If the identified payment card transaction data is approved, the at least one host computing device is further configured to either: initiate a cash value payment to the merchant for the amount of electrical energy; or initiate a delivery of the amount of electrical energy to an electrical energy storage device of the merchant.

### BACKGROUND

This disclosure relates generally to electronic payment systems for payment-by-card transactions, and more specifically to electronic payment card systems for processing electrical energy-based transactions between a cardholder and a merchant.

Electronic payment card processing systems are in widespread use to process transactions between a cardholder, a merchant, an acquirer bank, and an issuing bank. The transaction may involve the physical payment card itself at a point-of-sale terminal, a device associated with a payment card (or an account of a payment card) that includes payment card information and digital payment capability (e.g., a smart phone device including a digital wallet), or manually entered payment card information via another device such as a computer device interfacing with a merchant online. Sophisticated multi-party payment card processing systems are known to process payment card transactions, confirm authorized charges, manage payments and transfer of funds, confirm payment status, and compute available credit balances.

When a cardholder uses a payment card (e.g., a credit card or a debit card) to initiate a transaction to purchase goods or services from a merchant, an acquiring bank (i.e., the merchant's bank) will typically reimburse the merchant for the transaction. The acquiring bank will then settle those funds with an issuing bank of the account corresponding to the payment card by presenting transaction data, associated with the transaction, to a payment processor. In a process known as clearing, transaction data is communicated from the acquiring bank through the payment processor to the issuing bank. After clearing, settlement of the final payment occurs via the payment processor. Settlement is a process used to exchange funds between the acquiring bank and the issuing bank for the net value of a batch of all monetary transactions that have cleared for that processing day.

Conventional payment card systems are generally not suited for transactions involving forms or payment other than money that are sometimes desirable to merchants and some of their cardholder customers. In particular, an electrical energy exchange between certain merchants and some of their customers would be desirable, but is not easily accomplished using conventional payment systems and therefore is generally not even attempted. Payment card systems capable of conveniently and reliably completing such transactions presently do not exist. Improvements are accordingly desired.

### BRIEF DESCRIPTION

In one aspect, the disclosure provides an electronic payment card processing including at least one host computing device comprising at least one processor in communication with a memory device and a payment card issuer. The at least one host computing device is configured to: accept payment card transaction data; analyze the payment card transaction data to identify an electrical energy-based transaction, wherein the electrical energy-based transaction involves a purchase of a good or service by a cardholder in exchange for an amount of electrical energy payable to a merchant via the payment card; and submit the payment card transaction data for the identified electrical energy-based transaction to the payment card issuer for approval. If the identified payment card transaction data is approved, the at least one host computing device is further configured to either: initiate a cash value payment for the amount of electrical energy the merchant; or initiate a delivery of the amount of electrical energy to an electrical energy storage device of the merchant.

In another aspect, the disclosure provides a method for completing an electrical energy-based transaction between a cardholder and a merchant is disclosed. The method is implemented in an electronic payment card processing system including at least one host computing device having at least one processor in communication with a memory device and a payment card issuer. The method includes: accepting payment card transaction data with the at least one host device; analyzing the payment card transaction data by the at least one host device to determine whether the transaction data corresponds to an electrical energy-based transaction involving a purchase of a good or service by a cardholder in exchange for an amount of electrical energy payable to a merchant via the payment card; and submitting the payment card transaction data for the identified electrical energy-based transaction to the payment card issuer for approval. If the identified payment card transaction data is approved, the method includes either: initiating a cash value payment for the amount of electrical energy the merchant; or initiating a delivery of the amount of electrical energy to an electrical energy storage device of the merchant.

In another aspect, the disclosure provides a non-transitory computer readable medium that includes computer executable instructions for completing an electrical energy-based transaction between a cardholder and a merchant is disclosed. When executed by at least one host computing device having at least one processor in communication with a memory device and a multi-party payment processing system, the computer executable instructions cause the at least one host computing device to: accept payment card transaction data; analyze the payment card transaction data to determine whether the transaction data corresponds to an electrical energy-based transaction involving a purchase of a good or service by a cardholder in exchange for an amount of electrical energy payable to a merchant via the payment card and submit the payment card transaction data for the identified electrical energy-based transaction to the payment card issuer for approval. If the identified payment card transaction data is approved, the computer executable instructions further cause the at least one host computing device to either: initiate a cash value payment for the amount of electrical energy the merchant; or initiate a delivery of the amount of electrical energy to an electrical energy storage device of the merchant.

### BRIEF DESCRIPTION OF THE DRAWINGS

FIG. 1 is a schematic diagram illustrating an exemplary multi-party payment network system for processing payment card transactions.

FIG. 2 schematically represents an electrical energy-based transaction between a cardholder and a merchant.

FIG. 3 is a schematic diagram illustrating an exemplary computer system of the disclosure including a renewable energy resource host computing device that facilitates an electrical energy-based transaction.

FIG. 4 illustrates an example configuration of a user device for the system shown in FIGS. 1-3.

FIG. 5 is a schematic diagram of an example server computing device that may be used with the computer system shown in FIG. 3.

FIG. 6 shows an example configuration of a user account database within a computing device, along with other related computing components, that may be used to create, organize, and monitor a plurality of user data associated with a user.

FIG. 7 shows an exemplary process of completing an electrical energy-based transaction by the system shown in FIG. 3.

### DETAILED DESCRIPTION OF THE DISCLOSURE

The following detailed description illustrates embodiments of the disclosure by way of example and not by way of limitation. The description enables one skilled in the art to make and use the disclosure, describes several embodiments, adaptations, variations, alternatives, and uses of the disclosure, including what is presently believed to be the best mode of carrying out the disclosure.

The systems and methods of the disclosure allow flexible payment card transactions as desired between a merchant and a customer that involve an exchange of electrical energy resources, herein referred to as an electrical energy-based transaction. Such a transaction may be especially desirable for a cardholder who owns a renewable energy power generation system and a merchant that owns a backup electrical power system.

The benefits of photovoltaic power systems to real estate property owners are increasingly recognized as the costs of obtaining and installing photovoltaic power systems continues to fall. Photovoltaic solar panels may be used in an array, or in some embodiments a single solar panel may be provided. Solar panels may be mounted on rooftops or another suitable location on a property, with each solar panel provided including solar modules or solar cells that convert light energy from the sun to electricity according to well-known photovoltaic principles and effect. In the case of multiple solar panels, the electricity produced by each solar panel may be combined and may be used to power electrical loads of a residence or business. Photovoltaic power systems confer an ability for property owners to disconnect from the power grid and avoid payments, or otherwise reduce payments, to a third party electrical power provider such as a conventional electric company. Over time, such cost savings may exceed the costs of obtaining and installing a photovoltaic power system, and as the cost of photovoltaic power systems continues to fall, property owners may recoup their costs in a shorter period of time.

Further, in instances wherein a photovoltaic power system generates more power than needed by the residence or business, the excess electrical energy may be “sold” by providing energy generated by the photovoltaic power system to the power grid for use by other consumers. In exchange for the excess energy supplied back to the power grid, the property owner may receive a credit from the electric company or other utility or entity operating the power grid. Such credit may be deducted from the property owner's account with the electric company. In some cases, certain property owners may enjoy a net zeroing of their electrical power bills via the combination lower power bills from reduced consumption of power from the third party power company and credits from the third party power company for the excess energy supplied to the grid by their photovoltaic power systems. At present, however, the excess energy generated by photovoltaic power systems and/or any associated credits may not be utilized as payment for other types of transactions.

Many merchants have backup power systems with secondary electrical energy power supplies for use in times when the conventional power grid is unable to supply electrical power to their business. As such, in times of a power outage for the conventional grid, backup power systems may be utilized to continue to operate the business without substantial interruption. Such backup power systems may save costs that businesses otherwise may incur in a power outage, but generally do not provide excess energy that can be “sold” to a third party like some owners of photovoltaic systems are able to do. Given the relatively high running costs for electrical power needed by merchants, however, merchants would benefit from any chance to reduce costs of obtaining electrical energy.

The systems and methods of the disclosure facilitate electrical energy-based transactions between cardholder customers and merchants. For cardholders having excess electrical energy resources via photovoltaic systems, electrical energy resource data may be loaded onto a payment card and may be used in lieu of a conventional monetary transaction with a merchant that desires alternative and lower cost electrical energy from sources other than conventional electric companies or utilities. The electrical energy resource data may be accepted as a form of payment when desired in an electrical energy-based transaction between a participating cardholder and a participating merchant. The merchant may realize the benefit of the electrical energy resource data transferred to the merchant in the transaction via a physical delivery of a corresponding amount of electrical energy to the merchant.

Advantageously, the systems and methods of the disclosure also allow a conventional exchange of money between merchants and customers, with the merchants and customers having selective ability to conduct transactions with electrical energy resource data only, a combination of electrical energy resource data and money, or money only. As such, the payment cards may be universally used by cardholders and accepted by different merchants to conduct electrical energy-based transactions, money-based transactions, or hybrids of electrical energy-based transactions and money-based transactions. The systems and methods of the disclosure may also convert any available electrical energy resource data to a monetary value at the option of the cardholder or the merchant for use in any given transaction.

The systems and methods of the disclosure may enroll cardholders with ability to collect electrical energy resources, merchants who have desire or ability to collect electrical energy resources, and any electrical power providers associated with a macro-grid or micro-grid to complete and account for electrical power delivery to and from cardholders and for electrical power delivery to enrolled merchants. The system and method of the disclosure may communicate with the macro-grid or micro-grid operator to determine electrical energy credits of a cardholder in more or less real-time as excess electrical energy is provided to the micro-grid or macro-grid by the cardholder's photovoltaic system, as well as more or less real-time cost information for electrical power resources that fluctuate over time. Such electrical energy credits may be loaded onto the payment card and made available as an independent form of payment with an enrolled merchant, or may be converted to a cash equivalent and integrated into the payment card balance available to the cardholder for a transaction with any desired merchant.

In an electrical energy-based transaction, electrical energy may be delivered to the enrolled merchant without cost to the merchant, while a corresponding amount of electrical energy resource data is deducted from the enrolled cardholder's account. Such electrical energy-based transactions may be incentivized when the value of the electrical resource data exceeds the value of the same transaction if conducted with money instead of electrical resources. For example, 1 credit of electrical energy loaded onto the card may be valued at more than 1 dollar, such that each of the cardholder and the merchant have motivation to exchange the credit of electrical energy rather than money. Consequently, even further cost savings to the cardholder are possible, while the merchant may receive delivery of electrical energy in exchange for the good or service underlying the transaction. Such delivery may be made to an electrical energy storage device such as a battery that may be part of a backup power supply of the merchant. Such delivery may include an accumulated delivery of electrical energy to the battery of the merchant over time, or a physical, bulk-transfer delivery of electrical energy via a separate energy storage device that the merchant may use.

While energy credits may accrue to a cardholder via operation of a photovoltaic power system, other renewable electrical power generation systems and energy credit accrual is possible via alternative systems such as miniature wind power systems or miniature hydro power systems. The photovoltaic power system aspects described herein are therefore provided for the sake of illustration rather than limitation.

In one embodiment, the disclosure provides an electronic payment card processing system including at least one host computing device comprising at least one processor in communication with a memory device and a payment card issuer. The at least one host computing device is configured to: accept payment card transaction data; analyze the payment card transaction data to identify an electrical energy-based transaction, wherein the electrical energy-based transaction involves a purchase of a good or service by a cardholder in exchange for an amount of electrical energy payable to a merchant via the payment card; and submit the payment card transaction data for the identified electrical energy-based transaction to the payment card issuer for approval. If the identified payment card transaction data is approved, the at least one host computing device is further configured to either: initiate a cash value payment to the merchant for the amount of electrical energy; or initiate a delivery of the amount of electrical energy to an electrical energy storage device of the merchant.

The at least one host computing device is also configured to: convert the amount of electrical energy to the cash value; and submit the cash value of the identified transaction for approval by the payment card issuer. The at least one host computing device may be in communication with an electrical energy provider device, and the at least one host computing device is further configured to generate a message to the electrical energy provider device to initiate delivery of the amount of electrical energy. The electronic payment card system may further include at least one database including renewable energy data associated with the payment card, wherein the renewable energy data is utilized to identify the electrical energy-based transaction. The renewable energy data may include currency conversion data. The at least one host computing device may also be configured to submit payment card transaction data that is not identified as an electrical energy-based transaction to the payment card issuer for approval.

The electrical energy storage device of the merchant may be an electrochemical energy storage device. The electrochemical energy storage device may include at least one battery. The at least one host computing device may also be configured to: receive renewable energy resource data from an electrical power provider device; match the renewable energy resource data to at least one cardholder; and utilize the matched data to identify an electrical energy-based transaction. The at least one host computing device may further be configured to notify the electrical power provider device of transaction data when an electrical energy-based transaction is approved.

In another embodiment of the disclosure, a method for completing an electrical energy-based transaction between a cardholder and a merchant is disclosed. The method is implemented in an electronic payment card processing system including at least one host computing device having at least one processor in communication with a memory device and a payment card issuer. The method includes: accepting payment card transaction data with the at least one host device; analyzing the payment card transaction data by the at least one host device to determine whether the transaction data corresponds to an electrical energy-based transaction involving a purchase of a good or service by a cardholder in exchange for an amount of electrical energy payable to a merchant via the payment card; and submitting the payment card transaction data for the identified electrical energy-based transaction to the payment card issuer for approval. If the identified payment card transaction data is approved, the method includes either: initiating a cash value payment to the merchant for the amount of electrical energy; or initiating a delivery of the amount of electrical energy to an electrical energy storage device of the merchant.

The method may also include converting the amount of electrical energy to the cash value; and submitting the cash value of the identified transaction for approval by the payment card issuer. The at least one host computing device is in communication with an electrical energy provider device, and the method may include generating a message to the electrical energy provider device to initiate delivery of the amount of electrical energy.

The electronic payment card processing system may also include at least one database including renewable energy data associated with the payment card, and the method may include utilizing the renewable energy data to identify an electrical energy-based transaction. The method may include converting the renewable energy data into to a monetary value.

The method of claim may additionally include receiving renewable energy resource data from an electrical power provider device; matching the renewable energy resource data to at least one cardholder; and utilizing the matched data to identify an electrical energy-based transaction. The method may also include notifying the electrical power provider device of transaction data when an electrical energy-based transaction is approved. Initiating a delivery of the amount of electrical energy to an energy storage device comprises initiating a delivery of the amount of electrical energy to the at least one battery.

In another embodiment of the disclosure, a non-transitory computer readable medium that includes computer executable instructions for completing an electrical energy-based transaction between a cardholder and a merchant is disclosed. When executed by at least one host computing device having at least one processor in communication with a memory device and a multi-party payment processing system, the computer executable instructions cause the at least one host computing device to: accept payment card transaction data; analyze the payment card transaction data to determine whether the transaction data corresponds to an electrical energy-based transaction involving a purchase of a good or service by a cardholder in exchange for an amount of electrical energy payable to a merchant via the payment card and submit the payment card transaction data for the identified electrical energy-based transaction to the payment card issuer for approval. If the identified payment card transaction data is approved, the computer executable instructions further cause the at least one host computing device to either: initiate a cash value payment to the merchant for the amount of electrical energy; or initiate a delivery of the amount of electrical energy to an electrical energy storage device of the merchant.

The non-transitory computer readable medium may also cause the at least one host computing device to: convert the amount of electrical energy to the cash value; and submit the cash value of the identified transaction for approval by a payment card issuer. The non-transitory computer readable medium may likewise cause the at least one host computing device to generate a message to the electrical energy provider device to initiate delivery of the amount of electrical energy.

The technical problems addressed by the payment card processing systems and methods of the disclosure include at least one of: (i) inability to process payment-by-card transactions involving non-monetary payment; (ii) inability of a cardholder having renewable energy credit to tender such credit in a transaction with a merchant; (iii) inability of a merchant to accept a renewable energy credit from a cardholder in a payment-by-card transaction; (iv) inability to account for renewable energy credits that are transferred between a cardholder and a third party merchant; (v) inability to convert renewable energy credits into a cash value for processing in an electronic card payment system; (vi) inability to coordinate electrical energy transfer between a cardholder and a merchant; and (vii) inability to selectively process electrical energy-based transactions and non-electrical energy-based transactions between cardholders and merchants with a single payment processing system.

The payment card processing systems and methods of the disclosure may be implemented using computer programming or engineering techniques including computer software, firmware, hardware, or any combination or subset thereof, wherein the technical effects may be achieved by: (i) electronically identifying payment-by-card transactions involving non-monetary forms of payment between a cardholder and a merchant; (ii) electronically facilitating a cardholder having renewable energy credit to tender such credit in a transaction with a merchant; (iii) electronically equipping a merchant to accept a renewable energy credit from a cardholder in a payment-by-card transaction; (iv) electronically accounting for renewable energy credits that are transferred between a cardholder and a third party merchant; (v) electronically converting renewable energy credits into a cash value for processing in an electronic card payment system; (vi) electronically coordinating electrical energy transfer between a cardholder and a merchant via an electrical power provider; and (vii) electronically processing electrical energy-based transactions and non-electrical energy-based transactions between cardholders and merchants with the same payment processing system.

The resulting technical benefits achieved by the payment card processing systems and methods include at least one of: (i) improving a payment card system by identifying and distinguishing payment-by-card transactions involving non-monetary forms of payment between a cardholder and a merchant from payment-by-card transactions involving monetary payments; (ii) electronically accepting a cardholder's renewable energy credit payment in a payment-by card transaction with a merchant; (iii) electronically administrating a renewable energy credit transfer from a cardholder to a merchant in a payment-by-card transaction; (iv) electronically communicating with a third party electrical provider to account for available renewable energy credits and transfer of renewable energy credits between a cardholder and a merchant; (v) electronically converting renewable energy credits into a cash value for processing in an electronic card payment system; (vi) electronically initiating and coordinating electrical energy transfer between a cardholder and a merchant via an electrical power provider; and (vii) electronically processing both electrical energy-based transactions and non-electrical energy-based transactions between cardholders and merchants with the same payment card processing system.

In one embodiment, a computer program is provided, and the program is embodied on a computer-readable medium. In an example embodiment, the system may be executed on a single computer system, without requiring a connection to a server computer. In a further example embodiment, the system may be run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Apple Inc. located in Cupertino, Calif.). In yet a further embodiment, the system is run on a Mac OS® environment (Mac OS is a registered trademark of Apple Inc. located in Cupertino, Calif.). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

In one embodiment, a computer program is provided, and the program is embodied on a computer-readable medium and utilizes a Structured Query Language (SQL) with a client user interface front-end for administration and a web interface for standard user input and reports. In another embodiment, the system is web enabled and is run on a business entity intranet. In yet another embodiment, the system is fully accessed by individuals having an authorized access outside the firewall of the business-entity through the Internet. In a further embodiment, the system is being run in a Windows® environment (Windows is a registered trademark of Microsoft Corporation, Redmond, Wash.). The application is flexible and designed to run in various different environments without compromising any major functionality.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus, are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the system and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are for example only, and are thus not limiting as to the types of memory usable for storage of a computer program.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, any type of virtual card (e.g. virtual cards generated by issuers and/or third party processors via mobile bank or desktop apps) and/or any other device that may hold payment account information, such as mobile phones, Smartphones, personal digital assistants (PDAs), key fobs, digital wallets, and/or computers. Each type of transactions card can be used as a method of payment for performing a transaction. As used herein, the term “payment account” is used generally to refer to the underlying account with the transaction card. In addition, cardholder card account behavior can include but is not limited to purchases, management activities (e.g., balance checking), bill payments, achievement of targets (meeting account balance goals, paying bills on time), and/or product registrations (e.g., mobile application downloads).

As used herein, the term “transaction data” refers to data that includes at least a portion of a cardholder's account information (e.g., cardholder name, account identifier, credit line, security code, and/or expiration data) and at least a portion of purchase information (e.g., price, a type of item and/or service, SKU number, item/service description, purchase date, and/or confirmation number) supplied by a merchant from which the cardholder is making a purchase.

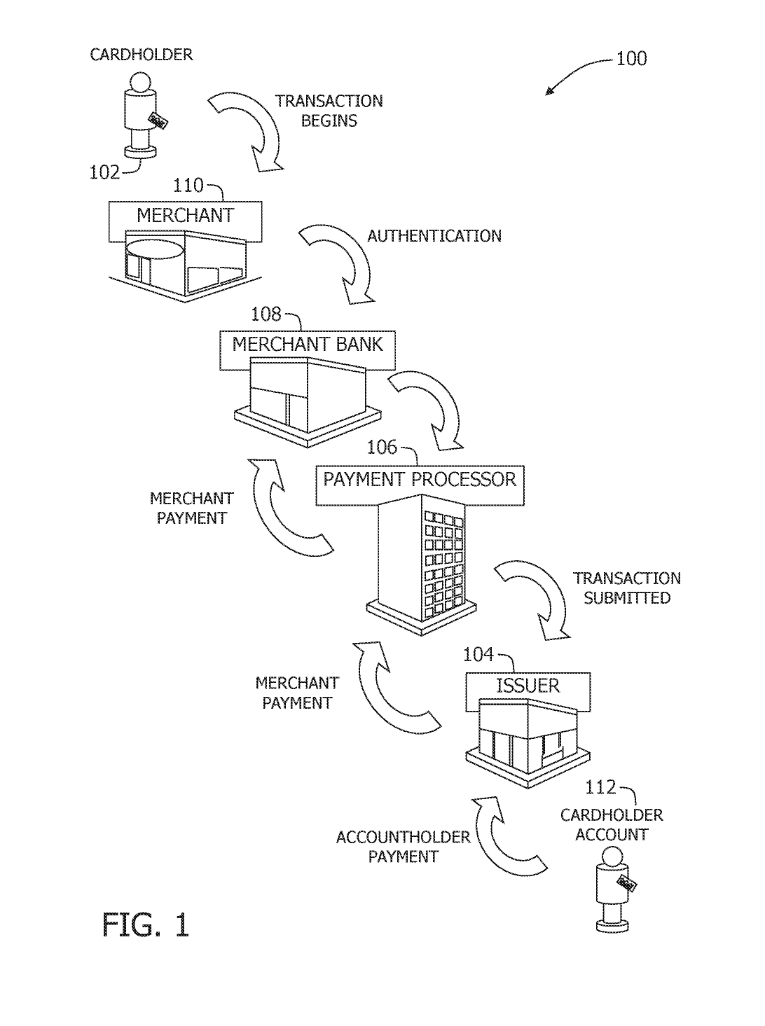

FIG. 1 is a schematic diagram illustrating an exemplary multi-party payment card processing system and network 100 for processing payment-by-card transactions. The present system and method relates to payment card processing network 100, such as a credit card payment network using the Mastercard® payment processor 106. Mastercard® payment processor 106 is a proprietary communications standard promulgated by Mastercard International Incorporated® for the exchange of financial transaction data between financial institutions that are registered with Mastercard International Incorporated®. (Mastercard is a registered trademark of Mastercard International Incorporated located in Purchase, N.Y.). Embodiments described herein may also relate to digital payment services such as Masterpass by Mastercard or another digital wallet service for a mobile device such as a smartphone.

In payment card processing network 100, a financial institution, such as an issuing bank 104, issues a payment card, such as a credit card account or a debit card account, to a cardholder 102, who uses the payment card to tender payment for a purchase from a merchant 110. To accept payment with the payment card, merchant 110 must normally establish an account with a financial institution that is part of the financial payment system. This financial institution is usually called the “merchant bank” or the “acquiring bank” or simply “acquirer”. When a cardholder 102 tenders payment for a purchase with a payment card (also known as a financial transaction card), merchant 110 requests authorization from merchant bank 108 for the amount of the purchase. The request may be performed over the telephone or via a website, but is oftentimes performed through the use of a point-of-sale terminal, which reads the cardholder's account information from the magnetic stripe on the payment card and communicates electronically with the transaction processing computers of merchant bank 108. Alternatively, merchant bank 108 may authorize a third party to perform transaction processing on its behalf. In this case, the point-of-sale terminal will be configured to communicate with the third party. Such a third party is usually called a “merchant processor” or an “acquiring processor.”

Using payment processor 106, the computers of merchant bank 108 or the merchant processor will communicate with the computers of issuing bank 104 to determine whether the cardholder's account is in good standing and whether the purchase is covered by the cardholder's available credit line or account balance. Based on these determinations, the request for authorization will be declined or accepted. If the request is accepted, the transaction is given a bank network reference number, such as the Banknet Reference Number used by Mastercard International Incorporated®, an authorization code, and/or other transaction identifiers that may be used to identify the transaction.

The payment network may be configured to process authorization messages, such as ISO® 8583 compliant messages and ISO® 20022 compliant messages. As used herein, “ISO®” refers to a series of standards approved by the International Organization for Standardization (ISO is a registered trademark of the International Organization for Standardization of Geneva, Switzerland). ISO® 8583 compliant messages are defined by the ISO® 8583 standard which governs financial transaction card originated messages and further defines acceptable message types, data elements, and code values associated with such financial transaction card originated messages. ISO® 8583 compliant messages include a plurality of specified locations for data elements. ISO® 20022 compliant messages are defined by the ISO® 20022 standard. For example, ISO® 20022 compliant messages may include acceptor to issuer card messages (ATICA).

During the authorization process of the payment card processing system, the clearing process is also taking place. During the clearing process, merchant bank 108 provides issuing bank 104 with information relating to the sale. No money is exchanged during clearing. Clearing (also referred to as “first presentment”) involves the exchange of data required to identify the cardholder's account 112 such as the account number, expiration date, billing address, amount of the sale, and/or other transaction identifiers that may be used to identify the transaction. Along with this data, banks in the United States also include a bank network reference number, such as the Banknet Reference Number used by Mastercard International Incorporated®, which identifies that specific transaction. When the issuing bank 104 receives this data, it posts the amount of sale as a draw against the available credit in the cardholder account 112 and prepares to send payment to the merchant bank 108.

When a request for authorization is accepted, the available credit line or available account balance of cardholder's account 112 is decreased. Normally, a charge is not posted immediately to a cardholder's account 112 because bankcard associations, such as Mastercard International Incorporated®, have promulgated rules that do not allow a merchant to charge, or “capture,” a transaction until goods are shipped or services are delivered. When a merchant 110 ships or delivers the goods or services, merchant 110 captures the transaction by, for example, appropriate data entry procedures on the point-of-sale terminal. If a cardholder 102 cancels a transaction before it is captured, a “void” is generated. If a cardholder 102 returns goods after the transaction has been captured, a “credit” is generated.

After a transaction is captured, the transaction is settled between merchant 110, merchant bank 108, and issuing bank 104. Settlement refers to the transfer of financial data or funds between the merchant's account, merchant bank 108, and issuing bank 104 related to the transaction. Usually, transactions are captured and accumulated into a “batch,” which is settled as a group.

The transactions described above are referred to herein as monetary transactions, and are distinguished from non-monetary transactions including alternative forms of payments such as in the electrical energy-based transactions described next.

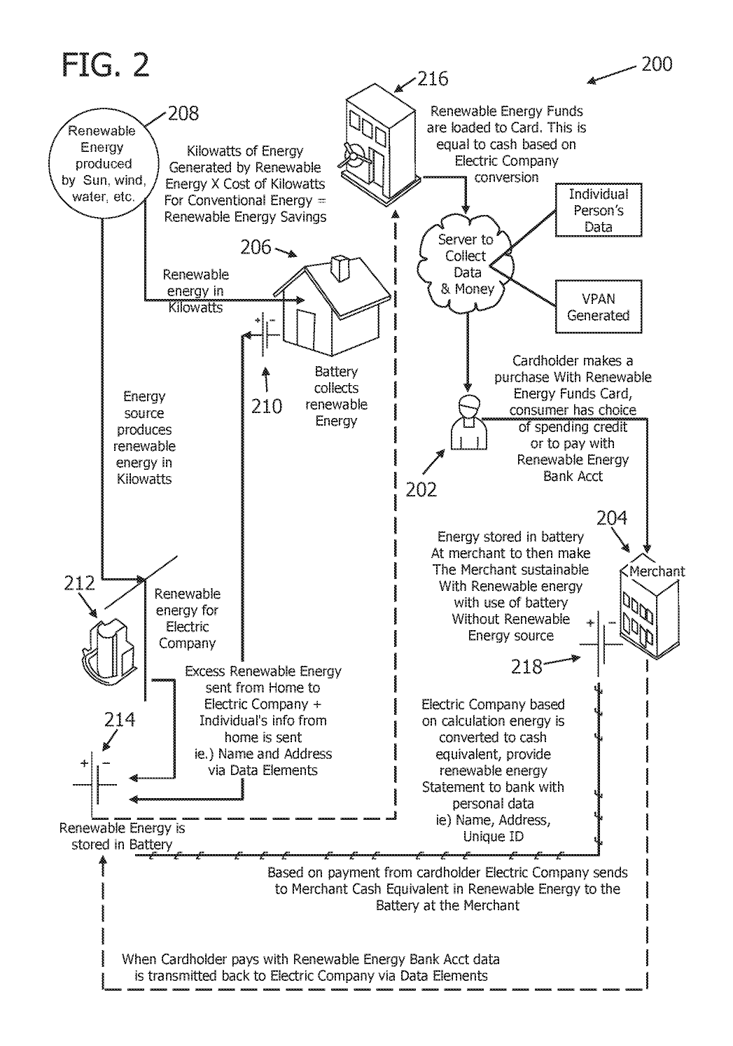

FIG. 2 schematically represents an electrical energy-based transaction between a cardholder 202 and a merchant 204. The cardholder 202 has a property 206 including a renewable energy system 208 such as a photovoltaic power system. As the renewable energy system 208 operates, it produces electrical energy that may be used to power electrical devices on the property 206. At times when the renewable energy system 208 produces more electrical energy than is needed by the property, the excess electrical energy may optionally be stored in an electrochemical storage device 210 for later use on the property, or provided back to an electrical provider 212 such as an electric company or other grid operator that oversees the power grid (either a macro-grid or micro-grid) supplying power to the property 206 when the renewable energy system 208 is not able to provide sufficient electrical power on its own. As shown, the electrical provider 212 may also have its own storage device 214 that may collect energy from the cardholder's storage device 210.

Excess electrical energy that is returned to the electrical provider 212 is typically credited to the cardholder by the electrical provider in a conventional manner. Metering components and the like are provided to monitor the excess energy return from the system 208 and are applied to the cardholder's account with the electrical provider 212. Considering that the same electrical provider may receive energy from multiple renewable energy systems 208 at multiple properties, identifiers and other data elements are communicated along with metering information from each of the renewable energy systems 208 such that the electrical provider 212 can apply credits to each respective account. The renewable energy credits may be deducted from invoices issued by the electrical provider 212 for service to each property 210 and associated account and as such the renewable energy systems 208 provide short term and long term cost savings to the property owners/cardholders 202.

The systems and methods of the disclosure provide another way for the property owners/cardholders 202 to beneficially utilize their renewable energy credits in a more flexible manner for greater convenience, and at times greater value, in a payment-by-card transaction with a third party merchant 204. To facilitate this, a payment card system 216 is shown and described in detail below that includes at least one computing device that is configured to load renewable energy credits onto a payment card and make them available to cardholders 202 as possible funds to complete a transaction with third party merchants 204. Beneficially, the cardholders 202 may complete conventional monetary-based transactions such as those described above and the electrical energy-based transactions with the same payment card that is processed by the same payment system. Payment card transactions completed by the system and method of the disclosure may be entirely monetary, entirely energy-based, or hybrid transactions including part monetary payment in part and non-monetary payment in part. Also, the system and method of the disclosure may convert the renewable energy credits to a cash value to be applied by the payment system when desired or needed.

As shown in the example of FIG. 2, the merchant 204 has an electrical energy storage device such as a battery 218. The battery 218 may be part of an emergency back-up power system or a stand-alone element to complete electrical energy based transactions. When the cardholder 202 opts to fund a payment card transaction with the merchant 204 using renewable energy credit funds, the merchant may receive delivery of the corresponding amount of electrical energy to the battery 218. When needed, the battery 218 may be used to provide electrical power to the merchant facility. Therefore, when desired, merchants 204 may provide goods and services to cardholders 202 in exchange for actual electrical energy rather than conventional monetary payments. Considering that the value of the actual electrical energy exchanged may be greater than the dollar value of the same transaction, both cardholders and merchants are incentivized to conduct electrical energy-based transactions when possible.

The system 216 communicates with payment processors, issuing banks and electrical providers to fully account for renewable energy credits as they are generated and made available to cardholders to spend, as they are redeemed to account invoices of the electrical provider, and as they are applied to electrical energy-based transactions that are approved by the payment card system 216. The system may communicate with the electrical provider to load renewable energy credits onto payment cards for enrolled cardholders, may communicate back to the electrical provider when electrical energy-based transactions are completed for adjustment of the renewable energy credits, as well as compute available credit lines in both conventional monetary terms and renewable energy credits.

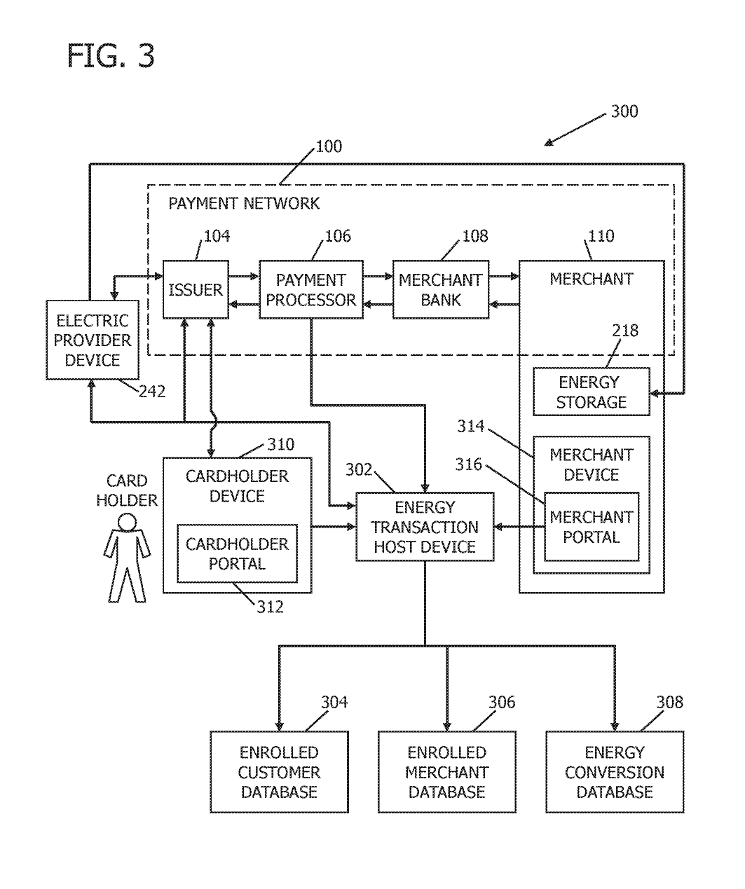

FIG. 3 is a schematic diagram illustrating an exemplary system 300 that facilities and coordinates the electrical energy-based transactions illustrated in FIG. 2 and related affiliate agreements between merchants.

The system 300 includes an energy transaction host computing device 302 in communication with the payment network 100 (FIG. 1) including the issuer 104, payment processor 106, merchant bank 108 and merchant 110 (FIG. 1) or merchant 204 (FIG. 2). The energy transaction host computing device 302 is further in communication with an enrolled customer database 304, an enrolled merchant database 306, and an energy conversion database 308. A cardholder may further use a cardholder device 310 and cardholder portal 312 accessible via the cardholder device 310 to interact with the energy transaction host computing device 302, and the merchant 110 may use a merchant device 314 and merchant portal 316 accessible via the merchant device 314 to interact with the energy transaction host computing device 302.

A cardholder using the cardholder computing device 310 may enroll as a participating cardholder in the energy transaction host computing device 302. Enrollment may include acceptance of energy transaction service terms, renewable energy system information identification information, account information for the applicable electrical provider 242 so that the system may send and receive renewable energy credit data and information, preferences for energy transaction services for any desired energy transaction, preferred contact information for any energy transaction service notifications and the like (e.g., email, SMS text notification, push notification, notification via a digital wallet service, etc.), or other desired information relating to the cardholder to provide the energy transaction services.

In contemplated embodiments, the enrollment includes opt-in informed consent of users to data usage by the system consistent with consumer protection laws and privacy regulations. In some embodiments, the enrollment data and/or other collected data may be anonymized and/or aggregated prior to receipt such that no personally identifiable information (PII) is received. In other embodiments, the system may be configured to receive enrollment data and/or other collected data that is not yet anonymized and/or aggregated, and thus may be configured to anonymize and aggregate the data. In such embodiments, any PII received by the system is received and processed in an encrypted format, or is received with the consent of the individual with which the PII is associated. In situations in which the systems discussed herein collect personal information about individuals including cardholders or merchants, or may make use of such personal information, the individuals may be provided with an opportunity to control whether such information is collected or to control whether and/or how such information is used. In addition, certain data may be processed in one or more ways before it is stored or used, so that personally identifiable information is removed.

The services provided by the energy transaction host computing device 302 are contemplated as an opt-in services such that only specifically enrolled cardholders may experience such services. Permission to utilize location services in the cardholder device 310 may be obtained as part of the enrollment process. Such opt-in consent may be made in any manner desired and accepted by the energy transaction host computing device 302. In some embodiments, the opt-in consent may be made through a digital wallet service or application residing on the cardholder device 310, and a digital wallet service may provide the cardholder portal 312 shown in FIG. 3. More than one cardholder portal 312 is possible, however, using different devices of the cardholder. The cardholder portal 312 may be the same portal provided for other purposes to allow the cardholder to check payment card transaction activity, review account balances, review payment history, dispute charges, etc. or alternatively may be a unique portal specific to the energy transaction host computing device 302.

Once a cardholder is enrolled, cardholder information is stored in the enrolled customer database 304. As payment card transactions are made and processed by the payment network 100, the energy transaction host computing device 302 can retrieve information from the enrolled customer database 304 in order to identify a payment-by-card transaction made by an enrolled cardholder and also determine whether or not the payment-by-card transaction relates to an electrical energy-based transaction or not. For example, the energy transaction host computing device 302 may compare a primary account number (PAN) of a payment-by-card transaction from, for example, the payment processor 106 in the payment network 100 as a payment-by-card transaction is completed to see if it corresponds to the PAN of an enrolled cardholder. Preferences and cardholder profile information may also be retrieved for purposes of notice generation (or lack thereof) by the energy transaction host computing device 302.

A merchant 204 using the merchant computing device 314 may enroll as a participating merchant in the energy transaction host computing device 302. Merchant enrollment may include acceptance of energy transaction service terms, and acceptance of merchant profile information for use by the energy transaction host computing device 302. The merchant profile may include the merchant name and location(s) of their stores, applicable market segment identifiers and descriptors (e.g., grocery, sporting goods, restaurant, cinema), merchant preferences for the energy transaction services, contact information and notification preferences for any notices generated, and any other information desired. Once a merchant is enrolled, merchant information is stored in the enrolled merchant database 306 for use by the energy transaction host computing device 302 to provide the energy transaction services.

In operation, energy transaction host computing device 302 receives information from the electrical provider 242 regarding renewable energy credits generated by the cardholder renewable energy system 208 (FIG. 2). The energy transaction host computing device 302 may, in turn, communicate the credit renewable credit information to the issuer 104 for the purpose of approving payment card transactions using the renewable energy credits, as well as communicate the renewable energy credits to the cardholder via the cardholder portal 312. Recognizing that the energy credits are dynamic in nature and may change throughout the day, the energy transaction host computing device 302 communicates with a device of the electrical energy provider in more or less real-time to ensure that as of the time that payment card transactions are completed, the renewable credit information is current and accurate.

When a transaction is made between an enrolled cardholder and an enrolled merchant using the renewable energy credits as a form of payment, the energy transaction host computing device 302 receives information from the card processor 106 as payment-by-card transactions are made. Referencing the enrolled customer database 304, the energy transaction host computing device 302 can identify whether a transaction relates (or not) to an enrolled cardholder and an enrolled merchant. If the transaction does not relate to an enrolled cardholder and an enrolled merchant the energy transaction host computing device 302 processes the transaction as a conventional, monetary transaction as described above in relation to FIG. 1.

If a given transaction does relate to an enrolled cardholder and an enrolled merchant the energy transaction host computing device 302 may further determine whether the transaction actually involves electrical energy funds. Specifically, a data field may indicate whether or not the transaction between the enrolled cardholder and the enrolled merchant involves electrical energy credits as payment in whole or in part for goods or services. On this point, it is recognized that a cardholder may have energy credits available but choose not to use them, and a merchant may likewise choose not to accept energy credits. Accordingly, if cardholder energy credits are accepted for any given transaction, the merchant device 314 can add the data field for recognition by the energy transaction host computing device 302 that can further identify the transaction as being electrical energy-based to the payment processor 106 and/or the issuer 104 as the transaction data is submitted to the payment system 100 for approval. Before submitting the transaction data to the payment system 100, the energy transaction host computing device 302 may confirm that sufficient energy credits exist for the transaction, which also may be again by the issuer 104.

The energy transaction host computing device 302, in communicating with the payment system 100 and the issuer 104, may provide available credit information to the cardholder using the portal 312. The credit line information may include energy credit information and monetary information. For example, the cardholder may be provided a first available credit balance of $1500 and a second available energy credit balance of 15 kWh. For a particular transaction, the cardholder may choose to apply one or the other or both of the credit lines available to fund a transaction with an enrolled merchant.

An enrolled merchant may likewise have two effective price structures depending on whether a cardholder would like to pay in cash currency or renewable energy credits. For example, a given item may be priced by a merchant as for sale at a value of $25 or 15 kWh of energy. If he cardholder has 15 kWh or more of energy credits available to spend, the cardholder can choose to pay the 15 kWh if the merchant chooses to accept the 15 kWh, the cardholder may choose to pay in cash only (i.e., pay only $25 and keep the 15 kWh credit, or pay partly with each (e.g., 5 kWh with the remainder in dollars). A merchant may choose not accept any further energy credit payments, for example, when accepted energy credits cross a predetermined threshold that may correspond to a limit of the merchant to store the electrical energy in a storage device.

Recognizing that the value of energy credits may fluctuate over time, the energy transaction host computing device 302 may also convert available energy credits to a cash value at the time of the transaction for review by the cardholder and/or the merchant. If the case value of 1 unit of energy credit is worth more than 1 unit of currency (e.g., 1 dollar) then both the cardholder and the merchant are incentivized to use the energy credits instead of currency, subject to the merchant's ability to benefit to actually use the energy credits. The conversion to a cash value may be made on demand or automatically by the energy transaction host computing device 302. To facilitate the conversion, the energy transaction host computing device 302 may consult an energy conversion database 308 including conversion data for different types of renewable energy power systems (e.g., photovoltaic, water, or wind) in different seasons (e.g., winter versus summer), in specific locations (e.g., urban versus rural), and even at specific times of day (e.g., 6 am versus 4 pm). In less data intensive applications, energy conversion database 308 may include average values, but still may vary depending on location of the cardholder and/or merchant.

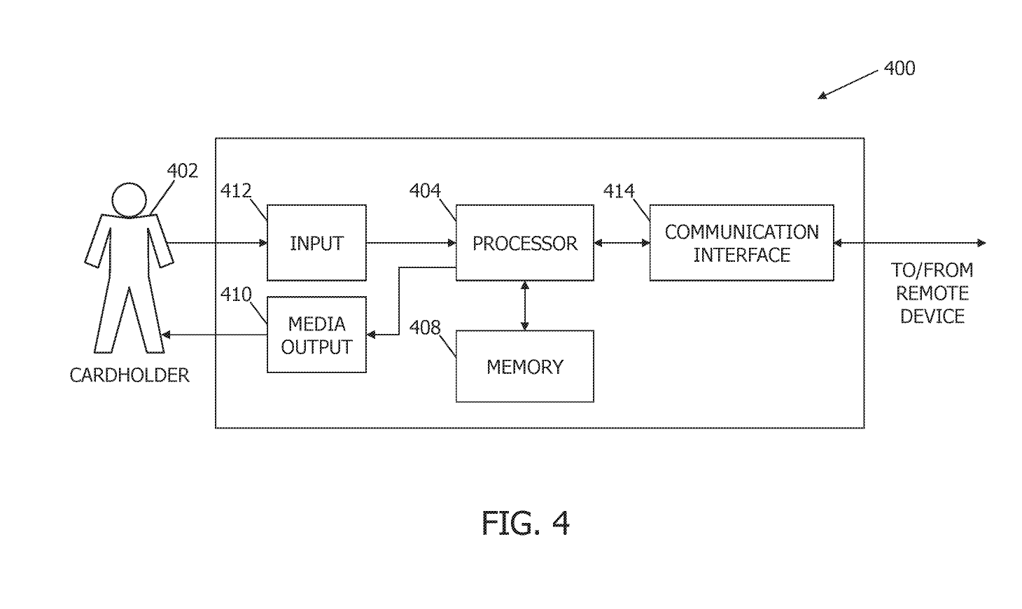

FIG. 4 illustrates an example configuration of a device 400 operated by a user 402, such as any of the parties described above. User device 400 may include, but is not limited to, a smart phone, a tablet, a notebook or laptop computer, a desktop computer, and a website. In the example embodiment, device 400 includes a processor 404 for executing instructions. In some embodiments, executable instructions are stored in a memory area 408. Processor 404 may include one or more processing units, for example, a multi-core configuration. Memory area 408 is any device allowing information such as executable instructions and/or written works to be stored and retrieved. Memory area 408 may include one or more computer readable media.

The device 400 may also include at least one media output component 410 for presenting information to user 402. Media output component 410 is any component capable of conveying information to user 402. In some embodiments, media output component 410 includes an output adapter such as a video adapter and/or an audio adapter. An output adapter is operatively coupled to processor 404 and operatively couplable to an output device such as a display device, a liquid crystal display (LCD), organic light emitting diode (OLED) display, or “electronic ink” display, or an audio output device, a speaker or headphones.

In some embodiments, the device 400 includes an input device 412 for receiving input from user 402. Input device 412 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 410 and input device 412. The device 400 may also include a communication interface 414, which is communicatively couplable to a remote device in the card payment system network or with other remote devices via networks other than the payment system. Communication interface 414 may include, for example, a wired or wireless network adapter or a wireless data transceiver for use with a mobile phone network, Global System for Mobile communications (GSM), 3G, or other mobile data network or Worldwide Interoperability for Microwave Access (WIMAX), or an 802.11 wireless network (WLAN).

Stored in memory area 408 are, for example, computer readable instructions for providing a user interface to user 402 via media output component 410 and, optionally, receiving and processing input from input device 412. A user interface may include, among other possibilities, a web browser and client application. Web browsers enable users, such as user 402, to display and interact with media and other information typically embedded on a web page or a website. An application allows user 402 to interact with a server application from a server system.

Multiple user devices 400 are contemplated and respectively provided for use by cardholders, representatives of the issuer, representatives of the payment processor, representatives of the merchant bank, representatives of merchants, and representatives of the energy transaction host computing device 302, and representatives of the electrical provider to effect the system as shown in FIG. 3. Additional and/or alternative users and user devices may be provided, however, as desired for use with the system 300.

In a variety of contemplated examples, different combinations of user devices, being the same or different from one another, may be utilized in the system with otherwise similar effect. One or more of the user devices may be a mobile device, such as any mobile device capable of interconnecting to the Internet including a smart phone, personal digital assistant (PDA), a tablet, or other web-based connectable equipment. Alternatively, one or more of the user devices may be a desktop computer or a laptop computer. Each of the user devices may be associated with a different user as described. Each user device may be interconnected to the Internet through a variety of interfaces including a network, such as a local area network (LAN) or a wide area network (WAN), dial-in connections, cable modems and special high-speed ISDN lines.

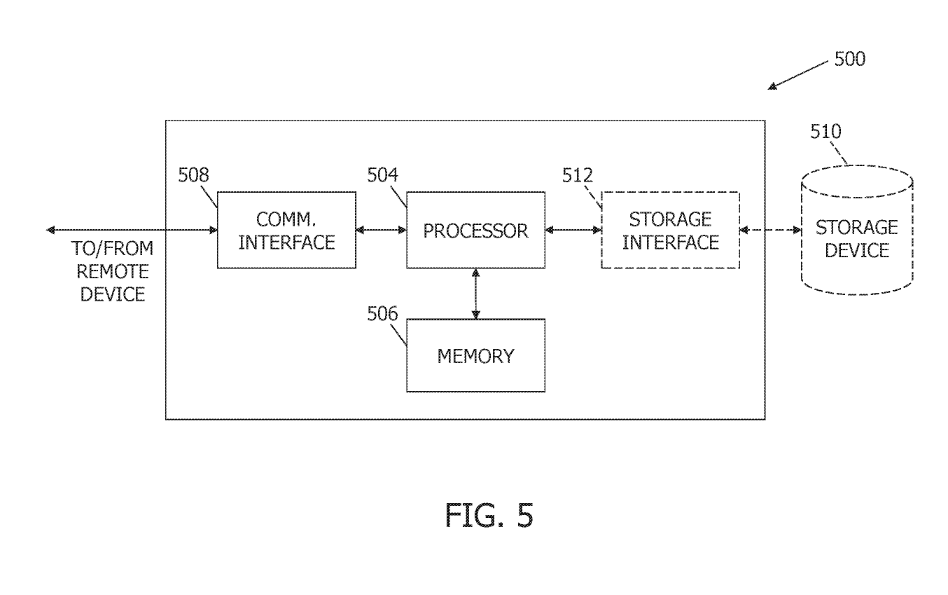

FIG. 5 illustrates an example configuration of an energy transaction host computing device 500 that confers the energy transaction services described above. The computing device 500 is sometimes referred to herein as a server-based network “host” device that coordinates and manages electrical energy-based transactions and/or monetary-based transactions described above, although it is not strictly necessary in all embodiments that the host computing device is a server system.

As shown in FIG. 5, the energy transaction host computing device 500 includes a processor 504 for executing instructions. Instructions may be stored in a memory area 506, for example. Processor 504 may include one or more processing units (e.g., in a multi-core configuration).

Processor 504 is operatively coupled to a communication interface 508 such that energy transaction host computing device 500 is capable of communicating with a remote device such as a merchant portal, an issuing portal, an electrical provider portal, a delivery agent portal or a payment processor. For example, communication interface 508 may receive or transmit transaction data, enrolled cardholder data, enrolled merchant data, affiliate agreement data, etc. to the cardholder portal, merchant portal, a payment processor, and/or another client device via a network.

Processor 504 may also be operatively coupled to a storage device 510. Storage device 510 is any computer-operated hardware suitable for storing and/or retrieving data. In some embodiments, storage device 510 is integrated in energy transaction host computing device 500. For example, energy transaction host computing device 500 may include one or more hard disk drives as storage device 510. In other embodiments, storage device 510 is external to energy transaction host computing device 500 and may be accessed by a plurality of server computer devices. For example, storage device 510 may include multiple storage units such as hard disks or solid state disks in a redundant array of inexpensive disks (RAID) configuration. Storage device 510 may include a storage area network (SAN) and/or a network attached storage (NAS) system.

The storage device 510 may include a database server and database which contains information and transaction data for enrolled cardholders, enrolled merchants, and energy credit conversion information and data. In one embodiment, the database is centralized and stored on the server system 500. In an alternative embodiment, the database is stored remotely from the server system 500 and may be non-centralized. The database may store transaction data including data relating to merchants, merchant locations, cardholders, cardholder location, and affiliate fee agreements and accounting.

In some embodiments, processor 504 is operatively coupled to storage device 510 via a storage interface 512. Storage interface 512 is any component capable of providing processor 504 with access to storage device 510. Storage interface 512 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 504 with access to storage device 510.

Memory area 506 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

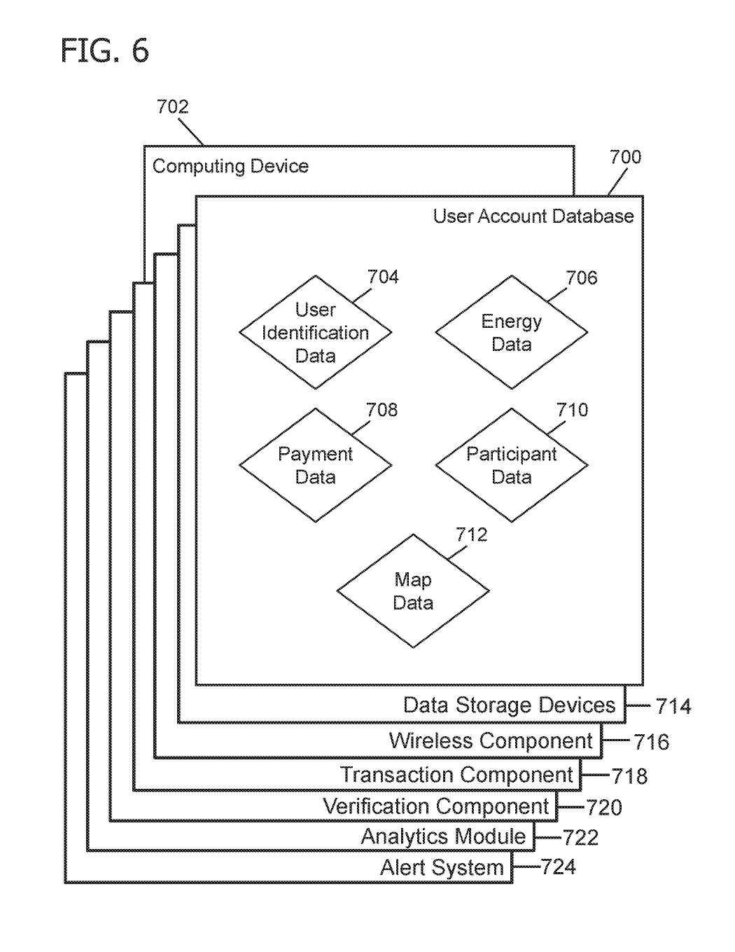

FIG. 6 shows an example configuration of a user account database 700, within a computing device 702, along with other related computing components, that may be used to create, organize, and monitor a plurality of user data associated with a user account. In some embodiments, computing device 702 is the same or similar to server system 500. User account database 700 is coupled to several separate components within computing device 702, which perform specific tasks.

In the example embodiment, database 700 includes user identification data 704, electric energy and credit data 706, payment data 708, participant data 710, and map data 712. In contemplated embodiments, user identification data 704 includes, but is not limited to, a user name, a user address, and a user phone number. Payment data 708 includes, but is not limited to, card information, payment history, and a billing address. Participation data 710 includes information associated with participating merchants, including merchant identifiers, address information, contact information, etc. Participant data 710 may also include data associated with third party information (e.g., system administrators). Map data 712 may include electrical grid infrastructure, participating merchant locations, and renewable energy power generation system locations of enrolled customers to facilitate power delivery and transfer aspects of the system described, and general oversight and visualization of local grid systems (macro-grid or micro-grid) having appropriate controls and distribution capability, or virtual power plant systems and the like.

Computing device 702 includes the database 700, as well as data storage devices 714. Computing device 702 also includes a wireless component 716 and a transaction component 718 for correlating, for example, payment card transactions. An analytics module 722 is included for analyzing transactions, enrollment status, incentive offers generated, incentive offers redeemed, affiliate fee payment determination, and other items of interest. Further included is a verification module 720 that may communicate with a device in the payment network or another device, and an alert module 724 for transmitting an alert to a cardholder, merchant or any other party.

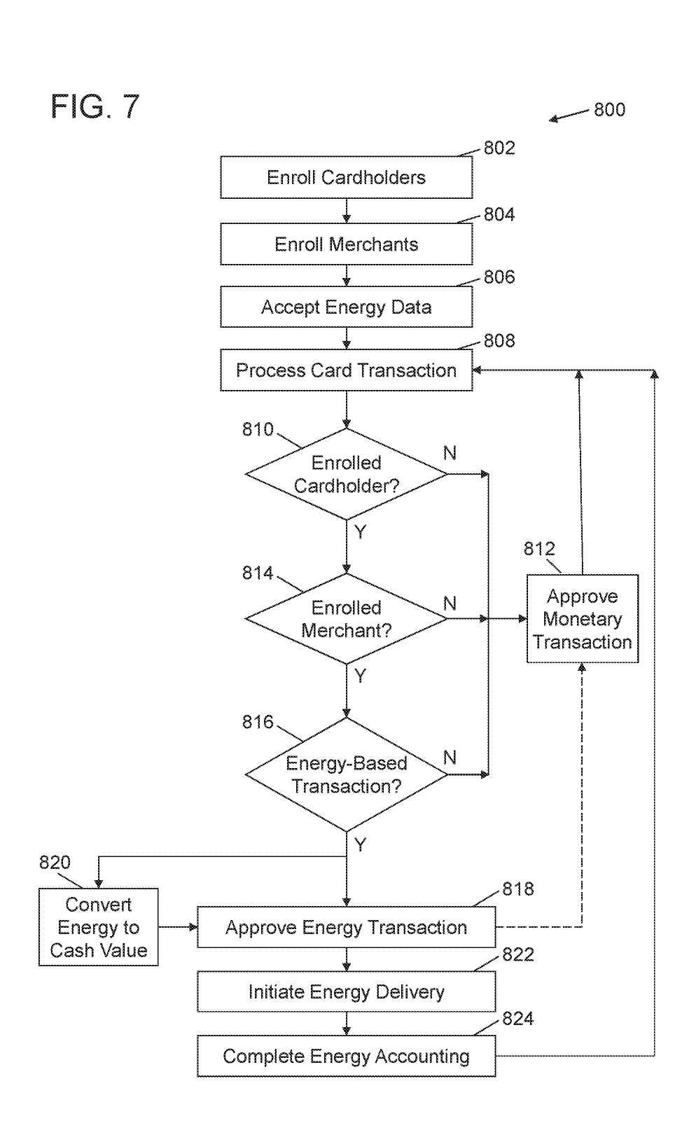

FIG. 7 shows an exemplary process 800 of completing an electrical energy-based transaction using the system 300 shown in FIG. 3 to complete an electrical energy-based transaction involving a purchase of a good or service by a cardholder in exchange for an amount of electrical energy payable to the merchant as shown in FIG. 2.

At step 802, cardholders are enrolled that may receive energy credits via operation of a renewable energy power generation system such as a photovoltaic power system or that otherwise have excess to electrical energy in a storage device that may be used in an electrical energy-based transaction. As contemplated, the cardholder enrollment includes opt-in informed consent consistent with application consumer protection and privacy laws and regulations. Cardholder profiles and preferences are accepted by the system as part of the enrollment. Also, as part of the enrollment step, cardholders may consent to use of energy transaction services on a cardholder device in relation to the system 300. An app may be made available for cardholders to download on their cardholder devices (e.g., smartphones) for convenient entry, review, and updates to their personal profile and settings or preferences for the energy transaction services provided. Otherwise, cardholders may access the system via a portal for initial enrollment, to check status, or change or update profiles, preferences or settings for the transaction services. The cardholder enrollment includes information for an associated electrical power provider for enrolled cardholders allowing the system to communicate directly with the electrical power provider as excess electrical energy and energy credits are made available.

At step 804, merchants are enrolled. Merchant enrollment may include acceptance of energy transaction information for a merchant location or locations, merchant profiles and preferences such as those described above. An app may be made available for merchants to download on their merchant devices (e.g., smartphones) for convenient entry, review, and updates to their merchant profile and settings or preferences for the energy transaction services provided. Otherwise, merchants may access the system via a portal for initial enrollment, check status, or change or update their profiles, preferences or settings for the energy transaction services. The merchant enrollment includes information for an associated electrical power provider for enrolled merchants allowing the system to communicate directly with the electrical power provider. From the merchant perspective, the electrical power provider information may facilitate delivery or transfer of electrical energy or energy credits.

At step 806, renewable energy data is accepted from electrical power providers of the enrolled merchants. The renewable energy data provides information regarding electrical energy resources available for use in an energy-based transaction. The electrical energy resources may be utilized in different forms as explained below.

In one aspect, the renewable energy data may include electrical energy credits issued to a cardholder via excess electrical energy provided back to the power grid of the electrical provider. The renewable energy data may be loaded on a payment card of the enrolled cardholder for use in completing an energy-based transaction. The renewable energy data may be reflected in an available credit balance viewable by the cardholder on his or her payment card account. The renewable energy credit balance may be provided separately from a conventional, currency based available credit line. For example, a cardholder logged in to their account may see an available credit balance of $1500 and 4 energy credits that may each be used separately or in combination to fund a payment card purchase with an enrolled merchant.

In another aspect, the renewable energy data may likewise include data from metering devices and the like that indicate an actual amount of electrical energy stored in a battery, battery bank, or other storage device(s) of either an enrolled cardholder or an enrolled merchant. As such, the system can conduct an energy-based transaction based on stored energy accumulated by a cardholder's renewable power generation system that has not been returned to the power grid, and as such no corresponding energy credit from the electrical provider has been issued. On the merchant side, the energy data for actual energy stored in a battery, battery bank, or other storage device(s) may allow the remaining storage capacity to be computed. As such, and for example, if the merchant has 60 kWh available in storage capacity, that merchant would not be able to accept more than 60 kWh in an energy-based transaction (or combination of energy-based transactions). Once the storage capacity of a merchant is met, the merchant may accept energy credits that will be used for the merchant account with an electrical provider, or the system may revert to monetary transactions only.

In still another aspect, the renewable energy data may include conversion data allowing electrical energy credits and actual amounts of stored electrical energy to be converted to a cash currency value when desired or when needed. The conversion data may include data from an electrical provider, data from external sources or third party providers, and may be real-time calculated values, averaged values over a period of time, or determined in another manner that merchants and cardholders may agree to as part of the enrollment steps. As described above, the value of electrical energy fluctuates over time, and as such at any given time the value of energy credits or the value of an amount of stored electrical energy may be different than at other times. The conversion data may also include conversion rates for energy credits so that the system can value them. For example, if an electrical provider issues 1 energy credit for each 15 kWh of energy provided back to the grid, the system can determine that 4 energy credits is equal to 60 kWh and can accordingly determine its value at the time of a transaction. As such, the system does not require that all electrical providers adopt the same energy credit units.

At step 808, payment-by-card transactions are processed on the transaction data generated and accepted by the system. As seen in steps 810, 814 and 816 several ways of identifying an energy-based transactions are utilized in combination to provide system redundancy and security in processing transactions.

At step 810, the transaction data is analyzed to determine if a processed transaction was made by an enrolled cardholder. For example, the system may compare a primary account number (PAN) of a processed transaction to see if matches a PAN of an enrolled cardholder. Also, the system may compare renewable energy data to cardholder data to identify an enrolled cardholder.

If the transaction data at step 810 does not relate to an enrolled cardholder, the transaction is not an electrical energy-based transaction. The system then proceeds at step 812 to approve the transaction (or not) as a monetary transaction in a conventional manner, and the system also returns to process another transaction at step 808.

If the transaction data at step 810 does relate to an enrolled cardholder, the system at step 814 analyzes the transaction data to determine if the processed transaction involves an enrolled merchant. For example, the system may compare a merchant identifier in the processed transaction to see if it matches an identifier of an enrolled merchant.

If the transaction data at step 814 does not relate to an enrolled merchant, the transaction is not an electrical energy-based transaction. The system then proceeds at step 812 to approve the transaction (or not) as a monetary transaction in a conventional manner, and the system also returns to process another transaction at step 808.

If the transaction data at step 814 does relate to an enrolled merchant, the system at step 816 analyzes the transaction data to determine if the processed transaction is or is not an energy-based transaction. For example, the system may detect or analyze a renewable energy data field in the transaction data that indicates the transaction as an energy-based transaction. In various different embodiments, the renewable energy data field may be included when an energy-based transaction is made and not included when a monetary transaction is made, or different codes may be provided in the same renewable energy data field to positively indicate whether the transaction is an energy-based transaction or a monetary transaction. For example, the code 01 in the renewable energy data field may indicate an energy-based transaction and the code 02 may indicate a non-energy-based transaction.

Recognizing that hybrid transactions are possible, the data field (or data fields) may indicate this as well. For example, a transaction may be completed using a payment of $100 and 15 energy credits, such that the data fields will show that both a monetary and non-monetary component of the transaction is present. An additional code may be provided in a renewable energy data field to indicate a hybrid transaction. For example, the code 0102 may be utilized in the renewable energy data field to indicate an energy-based component with the code 01 and a non-energy-based component with the code 02. Likewise, the code 03 could be used to indicate a hybrid transaction and distinguish it from code 01 (an energy-based transaction) and 02 (a non-energy-based transaction). Numerous variations are possible in this regard.

As another option, the system may identify an energy-based transaction based on matches in the renewable energy data and transaction data. For example, when renewable energy data is received from an electrical provider, identifiers of the electrical provider can be compared to identifiers in the transaction data to detect an energy-based transaction. For example, a data field can be included in the transaction data including an electrical provider identifier, an electrical provider account number, or other data. When such a data field is present, the system can infer an energy-based transaction, and when it is not present, the system may infer a non-energy-based transaction. Such data may also directly or indirectly relate to metering devices and the like and associated information.

If the transaction data at step 816 does not relate to an energy-based transaction, the system then proceeds at step 812 to approve the transaction (or not) as a monetary transaction in a conventional manner, and the system also returns to process another transaction at step 808. It is recognized that even between an enrolled cardholder and an enrolled merchant when energy credits or actual amounts of electrical energy exist that could fund a transaction in whole or in part, either the cardholder or the merchant could decline to utilize energy components to complete any given transaction.

If the transaction data at step 816 does relate to an energy-based transaction, the system then proceeds at step 818 to approve (or not) the energy-based transaction. As such, the transaction data may be submitted to the payment system for approval by the issuer. Optionally, and as shown at step 820, the energy components may be converted to a cash value for processing and approval. Additionally, the merchant may opt to accept the cash value of any energy credits used in the transaction, which may be approved or processed as a monetary transaction at step 812. The merchant's option to accept the energy credit, the cash value of an energy credit, an actual amount of electrical energy, or the cash value of an amount of electrical energy may be made in a transparent manner from the cardholder's perspective.

At step 822, if the energy-based transaction is approved the system may initiate energy delivery to the merchant. In doing so, the system may generate a message to the electrical provider of the merchant allowing the merchant to receive (and optionally store) a corresponding amount of electrical energy without invoicing the merchant for the corresponding amount of electrical energy. In this case, energy credits of a cardholder may be effectively transferred to the merchant for the merchant's benefit.

Alternatively, the system may message a third party delivery service to physically transfer the corresponding amount of electrical energy from the cardholder to the merchant. For example, a transfer of energy could be made, directly or indirectly, from one storage device (e.g., a battery) to another storage device to physically deliver energy to the merchant at the completion of an energy-based transaction.

Still further, energy transfer to the merchant could be accomplished via a virtual power plant system, or a smart grid system (macro-grid or micro-grid) having appropriate controls and distribution capability. Likewise, transactive energy systems including distributed energy resource capabilities, distributed power flow control capability, or peer to peer capabilities (e.g., blockchain systems and the like) may be utilized to accomplish the energy-based transactions described. Numerous variations are possible in these aspects.

Finally, as shown at step 824, the system completes energy accounting for the energy-based transaction by notifying the cardholder's electrical provider that energy credits have been utilized. The system likewise debits used energy credits and updates the cardholder's available credit, and generates desired records of the transactions completed.

As will be appreciated based on the foregoing specification, the above-described embodiments of the disclosure may be implemented using computer programming or engineering techniques including computer software, firmware, hardware or any combination or subset thereof, wherein the technical effects described above are achieved. Any such resulting program, having computer-readable code means, may be embodied or provided within one or more computer-readable media, thereby making a computer program product, (i.e., an article of manufacture), according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An electronic payment card processing system comprising:
at least one host computing device comprising at least one processor in communication with a memory device and a payment card issuer;
wherein the at least one host computing device is configured to:
accept payment card transaction data;
analyze the payment card transaction data to identify an electrical energy-based transaction, wherein the electrical energy-based transaction involves a purchase of a good or service by a cardholder in exchange for an amount of electrical energy payable to a merchant via the payment card;
submit the payment card transaction data for the identified electrical energy-based transaction to the payment card issuer for approval; and
if the identified payment card transaction data is approved, either:
initiate a cash value payment to the merchant for the amount of electrical energy; or
initiate a delivery of the amount of electrical energy to an electrical energy storage device of the merchant.

2. The electronic payment card system of claim 1, wherein the at least one host computing device is further configured to:
convert the amount of electrical energy to the cash value; and
submit the cash value of the identified transaction for approval by the payment card issuer.

3. The electronic payment card system of claim 1, wherein the at least one host computing device is in communication with an electrical energy provider device, and the at least one host computing device is further configured to generate a message to the electrical energy provider device to initiate delivery of the amount of electrical energy.

4. The electronic payment card system of claim 1, further comprising at least one database including renewable energy data associated with the payment card, wherein the renewable energy data is utilized to identify the electrical energy-based transaction.

5. The electronic payment card system of claim 4, wherein the renewable energy data includes currency conversion data.

6. The electronic payment card system of claim 1, wherein the at least one host computing device is further configured to submit payment card transaction data that is not identified as an electrical energy-based transaction to the payment card issuer for approval.

7. The electronic payment card system of claim 1, wherein the electrical energy storage device of the merchant is an electrochemical energy storage device.

8. The electronic payment card system of claim 7, wherein the electrochemical energy storage device comprises at least one battery.

9. The electronic payment card system of claim 1, wherein the at least one host computing device is further configured to:
receive renewable energy resource data from an electrical power provider device;
match the renewable energy resource data to at least one cardholder; and
utilize the matched data to identify an electrical energy-based transaction.

10. The electronic payment card system of claim 9, wherein the at least one host computing device is further configured to notify the electrical power provider device of transaction data when an electrical energy-based transaction is approved.

11. A method for completing an electrical energy-based transaction between a cardholder and a merchant, the method implemented in an electronic payment card processing system including at least one host computing device having at least one processor in communication with a memory device and a payment card issuer, wherein the method comprises:
accepting payment card transaction data with the at least one host device;
analyzing the payment card transaction data by the at least one host device to determine whether the transaction data corresponds to an electrical energy-based transaction involving a purchase of a good or service by a cardholder in exchange for an amount of electrical energy payable to a merchant via the payment card;
submitting the payment card transaction data for the identified electrical energy-based transaction to the payment card issuer for approval; and
if the identified payment card transaction data is approved, either:
initiating a cash value payment to the merchant for the amount of electrical energy; or
initiating a delivery of the amount of electrical energy to an electrical energy storage device of the merchant.

12. The method of claim 11, further comprising:
converting the amount of electrical energy to the cash value; and
submitting the cash value of the identified transaction for approval by the payment card issuer.

13. The method of claim 11, wherein the at least one host computing device is in communication with an electrical energy provider device, and the method further comprises generating a message to the electrical energy provider device to initiate delivery of the amount of electrical energy.

14. The method of claim 11, the electronic payment card processing system further including at least one database including renewable energy data associated with the payment card, and the method further comprising utilizing the renewable energy data to identify an electrical energy-based transaction.

15. The method of claim 14, further comprising converting the renewable energy data includes to a monetary value.

16. The method of claim 11, further comprising:
receiving renewable energy resource data from an electrical power provider device;
matching the renewable energy resource data to at least one cardholder; and
utilizing the matched data to identify an electrical energy-based transaction.

17. The method of claim 16, further comprising:
notifying the electrical power provider device of transaction data when an electrical energy-based transaction is approved.

18. The method of claim 11, wherein initiating a delivery of the amount of electrical energy to an energy storage device comprises initiating a delivery of the amount of electrical energy to at least one battery.

19. A non-transitory computer readable medium that includes computer executable instructions for completing an electrical energy-based transaction between a cardholder and a merchant, wherein when executed by at least one host computing device having at least one processor in communication with a memory device and a multi-party payment processing system, the computer executable instructions cause the at least one host computing device to:
accept payment card transaction data;
analyze the payment card transaction data to determine whether the transaction data corresponds to an electrical energy-based transaction involving a purchase of a good or service by a cardholder in exchange for an amount of electrical energy payable to a merchant via the payment card;
submit the payment card transaction data for the identified electrical energy-based transaction to the payment card issuer for approval; and
if the identified payment card transaction data is approved, either:
initiate a cash value payment to the merchant for the amount of electrical energy; or
initiate a delivery of the amount of electrical energy to an electrical energy storage device of the merchant.

20. The non-transitory computer readable medium of claim 19, the computer executable instructions further causing the at least one host computing device to:
convert the amount of electrical energy to the cash value; and
submit the cash value of the identified transaction for approval by a payment card issuer.

21. The non-transitory computer readable medium of claim 19, the computer executable instructions further causing the at least one host computing device to:
generate a message to the electrical energy provider device to initiate delivery of the amount of electrical energy.
